(19) United States
(12) Patent Application Publication
(10) Pub. No.: US 2003/0236885 A1
(43) Pub. Date: Dec. 25, 2003

(54) Method for data distribution and data distribution system

(76) Inventors: Tadashi Takeuchi, Yokohama (JP); Damien Le Moal, Sagamihara (JP); Ken Nomura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/262,105

(22) Filed: Oct. 2, 2002

(30) Foreign Application Priority Data
Oct. 11, 2001 (JP) 2001-313406

(51) Int. Cl. G06F 15/173

(52) U.S. Cl. 709/225

(57) ABSTRACT

In a data distribution method, for reducing network bandwidth and storage capacity necessary upon distributing stream data, a load of distributing the stream data is distributed or shared by each node on a network.

A stream server receives a distribution request from a client. The stream server manages or controls cache information (e.g., a title and a load, which is held by each stream cache, etc.) and title information (e.g., an access frequency of each title, etc.). The stream server selects the most suitable stream cache upon basis of the information mentioned above and a distance from the client in the sense of networks (i.e., the stream cache, which holds the title requested, near to the client in the sense of network distance, and operates under a low load), so as to give a data distribution command thereto. The steam server also instructs copying and deletion of the title to each stream cache, depending upon the access frequency of that title.

### BACKGROUND OF THE INVENTION

The present invention relates to a data distribution method and a caching method, as well as a data distributing system using thereof, and in particular to a stream data distributing method and a caching method (i.e., suppressing or reducing the Internet bandwidth and the capacity necessary to a storage to be low, and dividing the stream distribution load to each of nodes, equally) with high efficiency.

Conventionally, distribution of the stream data through the Internet is carried out under such the system configuration as shown in FIG. 1, for example.

When all of clients requesting the stream-data distribution (104-11 to 104-1N, 104-L1 to 104-LN) issue the request mentioned above to a stream server 102, and then the following problems will occur:

1) All requests from the clients are concentrated at the stream server 102, and then the stream server 102 comes to be bottleneck in the performance. As a result of this, the simultaneous distribution to a large number of clients cannot be obtained.

2) An amount of stream data flowing on the Internet 100 comes to large, and the Internet is crowed with. As a result of this, deterioration occurs in the quality of stream data during the distribution thereof on the Internet.

For dissolving such the problem as mentioned above, conventionally, each of the clients is connected to the stream caches (103-11 to 103-1M, 103-L1 to 103-LM) through an access network 101. Further, the stream caches connected to the same access network build up one stream cache cluster (for example, the stream caches 103-11 to 103-1M makes up one stream cache cluster 105-1).

Each client issues a stream data distribution request, not to the stream server 102, but to any one of the stream caches connected thereto via the access network of a self-node (for example, to any one of the stream caches 103-11 to 103-1M, in the case of the client 104-11).

Receiving the request, the stream cache checks on, whether the self-node holds or stores the stream data requested or not. If it stores the requested stream data therein, the stream cache distributes the stream data to the said client.

If it does not stores the requested stream data, the stream cache makes inquiry to other cache belonging to the same stream cache cluster, on whether it stores the said stream data or not. If there is a stream cache storing the stream data therein, the stream data is read out from said stream cache, and that data is distributed to the client. And also, said data is cached into the self-node.

On the other hand, if there is no stream cache storing said stream data therein, the stream data is read from the stream server 102, and said data is distributed to the client. Also, in addition thereto, said data is cached into the self-node.

Practicing the distribution and the caching of stream data in such the steps as mentioned above brings about the following advantages:

1) For the stream distribution server, it is enough to distribute the stream data to the stream cache, only when the stream data requested is not located within the stream cache and the stream cache cluster. As a result of this, the load of the stream server can be lightened or reduced down to a certain degree.

2) In the similar manner, the Internet bandwidth is consumed only in the cases as was mentioned above. As a result of this, the necessary bandwidth for the Internet can be reduced down to a certain degree.

However, with using or applying the stream distribution method and the caching method, in relation to the conventional art, the following problems occur:

1) It is insufficient in decentralization of the stream distribution load, and in reduction of a necessary amount of the Internet bandwidth. For example, if all stream caches within the stream cache cluster 105-1 are under the overload condition, as well as the stream server 102, the stream data is distributed from the stream cache within the stream cache cluster 105-L to the client, thereby enabling to escape from the overload condition. However, with the conventional art, the load decentralization mentioned above cannot be obtained. Further, if the stream cache cluster 105-L is located nearer than the stream server 102, in a sense of distance of the network from the client (for example, response speed is quicker), and if the requested stream data is stored only in the stream cache cluster 105-L and the stream server 102, then it is possible to reduce the necessary Internet bandwidth, by distributing the stream data from, not the stream server 102, but the stream cache within the stream cache cluster 105-L. However, with such the conventional art, it is necessary to conduct the stream distribution from that stream server.

2) In the stream cache, the capacity of the storage comes to be large for use in the stream data caching. For example, in case of the stream data that is not so high in access frequency thereof, it is enough for one stream cache within each stream cache cluster to cache said data therein. However, with the conventional art, since a plural number of the stream caches, which belong to the same stream cache cluster, cache said data therein, there is a possibility of wasting the storage capacity thereof.

### SUMMARY OF THE INVENTION

An object, according to the present invention, for dissolving the problems mentioned above, there is to provide a data distribution method, comprising the following steps of:

1) connecting a stream server, stream caches and clients through a network;

2) the client distributes data to the client with using the stream cache when the client transmits a data transmission request to the stream server;

3) the stream server selects the most suitable stream cache to transmit data to the client, upon basis of type of data held by each stream cache, positional information of the client located on the network, and load information of the each stream cache. Thus, as the most suitable stream cache is selected one that holds the data requested therein, that is near to the client in the sense of network distance (for example, being quick in response), and that operates under low load;

4) the stream server transmits a data distribute instruction to the stream cache selected in the above; and

5) the stream cache executes the data distribution in accordance with the instruction mentioned above.

### BRIEF DESCRIPTION OF THE DRAWINGS

FIG. 1 is a view for showing the configuration of a data distribution system, in relation to the conventional art;

FIG. 2 is a view for showing the configuration of a data distribution system, according to the present invention;

FIG. 3 is a view for showing a module configuration and a flow of control at each node in the data distribution system;

FIG. 4 is a view for showing the data structure of cache information (part 1);

FIG. 5 is a view for showing the data structure of cache information (part 2);

FIG. 6 is a view for showing the data structure of title information;

FIG. 7 shows a flowchart, in a case when a stream server receives a replay request from a client;

FIG. 8 shows a flowchart in a case when the stream server receives a stop request from the client;

FIG. 9 shows a flowchart in a case when the stream server performs monitoring on a stream cache, periodically;

FIG. 10 shows a flowchart in a case when title copying/deleting is generated accompanying with an increase/decrease in an access frequency; and

FIG. 11 shows the structure of a client, a reproduce-request processing module, and a distribution execution module in a second embodiment.

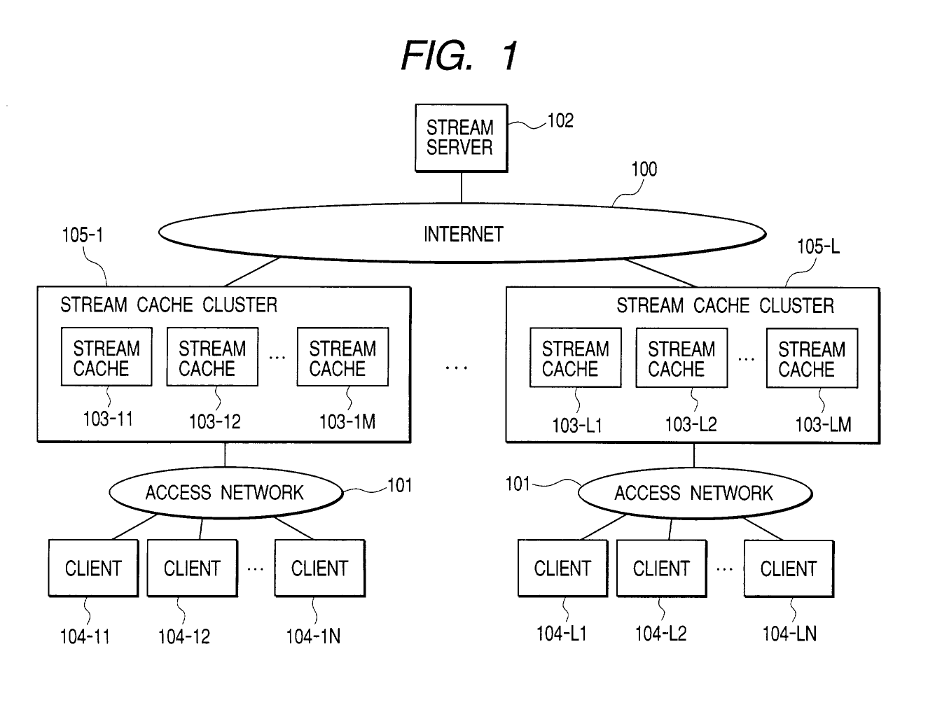

### DETAILED DESCRIPTION OF PREFERRED EMBODIMENTS

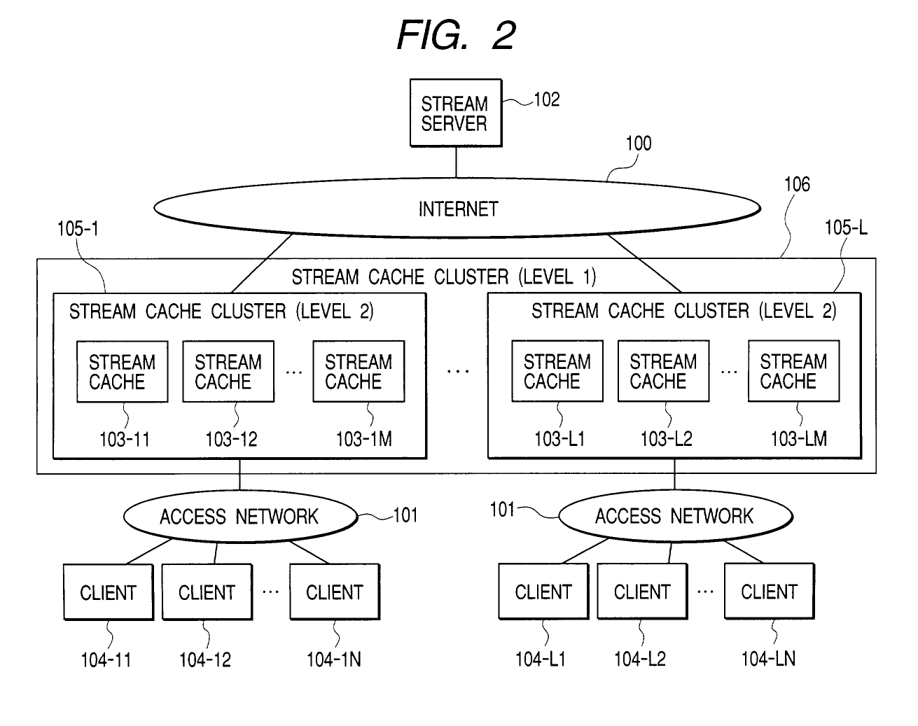

A first embodiment according to the present invention will be explained in details thereof, by referring to FIGS. 2 to 10.

FIG. 2 shows the system configuration of a stream data distribution system, according to the first embodiment of the present invention.

In the similar manner as in the conventional art, a stream server 102 is connected with client caches (103-11 to 103-1M, 103-L1 to 103-LM) and clients (104-11 to 104-1M, 104-L1 to 104-LM), through the Internet 100. Also in the similar manner as in the conventional art, stream caches, which are connected to the same access network, define one (1) stream cache cluster. However, being different from the conventional art, the stream cache cluster is built up in a form of the hierarchical structure, i.e., a plural number of the stream cache clusters are combined with, so as to define a stream cache cluster, being higher than those by one (1) in the levels thereof (in an example shown in FIG. 2, stream cache clusters 105-1 to 105-L define an upper stream cache cluster 106, being higher by one level).

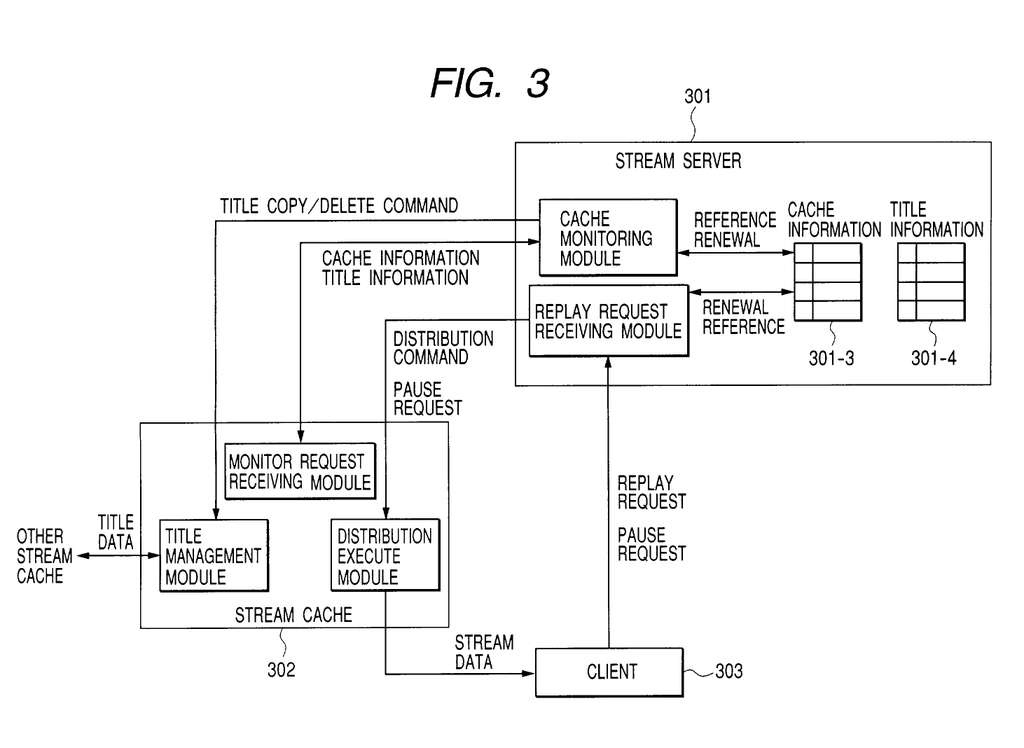

FIG. 3 is a view for showing the module configuration of each node shown in FIG. 2, the main data structure, and also flows of control between those modules.

A stream server 301 (corresponding to the stream server 102 shown in FIG. 2) comprises a cache monitoring module 301-1 and a replay request processing module 301-2.

The cache monitoring module 301-1 fills the following roles:

1) monitoring the condition of each stream cache (i.e., a load condition, a title on which caching is made, a distance to the client in the sense of network, etc.), periodically (through communication between a monitor request processing module 302-2), and recording it, as or in a form of cache information 301-3;

2) monitoring the condition (i.e., access frequency, etc.) of each title (i.e., a sort or type of the stream data), periodically (through communication between the monitor request processing module 302-2), and recording it, as or in a form of cache information 301-4;

3) changing the title to be cached by each stream cache depending upon the access frequency, which can be obtained as a result of the monitoring. In more detail, a title-copy instruction or a title-delete instruction is issued to a title management module 302-3. The title-copy instruction indicates to make a copy of the title, which is designated from other stream cache. The title-delete instruction indicates to delete the title indicted from the cache.

A replay request processing module 301-2 receives a replay request from the client 303. Upon making search on the cache information 301-1, the replay request processing module selects the most suitable stream cache to the client (i.e., the stream cache being equal or less than a predetermined value in the load condition thereof, and being at the minimum network distance to the client), thereby giving a distribution command to the said stream cache. The replay request processing module 301-2 also receives a pause request from the client 303. In this instance, the pause request is given to the stream cache distributing the stream data to the said client.

The stream cache 302 (corresponding to any one of the stream caches 103-11 to 103-1M, 103-L1 to 103-LM) comprises a distribution execute module 302-1, a monitoring request processing module 302-2, and a title management module 302-3.

A distribution execute module 302-1 receives a distribution command from the replay request processing module 301-2 of the stream server 301. In this distribution command are given the title to be distributed and the client, therefore the distribution of the stream data is conducted following to that instruction. It also receives the pause request from the replay request processing module 301-2. In this instance, the distribution of the steam data is stopped following to that instruction.

A monitoring request processing module 302-2 communicates with a cache monitoring module 301-1 of the stream server 301, periodically, thereby noticing the cache information and the title information thereto.

A title management module 302-3 receives the title-copy instruction and the title-delete instruction from the cache monitoring module 301-1 of the stream server 301. Upon receipt of the instruction mentioned above, the title management module executes copying of the title from other stream cache, as well as deletion of the title from the cache of the self-node.

For mentioning about the operation of the each module mentioned in FIG. 3, in more details thereof, hereinafter, description will be made on the data structures of the cache information and the title information. Furthermore, the operation of the each module will be mentioned below.

1) In the case when the stream server receives the replay request from the client

2) In the case when the stream server receives the stop request from the client

3) In the case when the stream server performs the periodical monitoring on the stream cache

4) In the case when testing is made on a necessity of the title copying/deleting, accompanying with increase/decrease in the access frequency

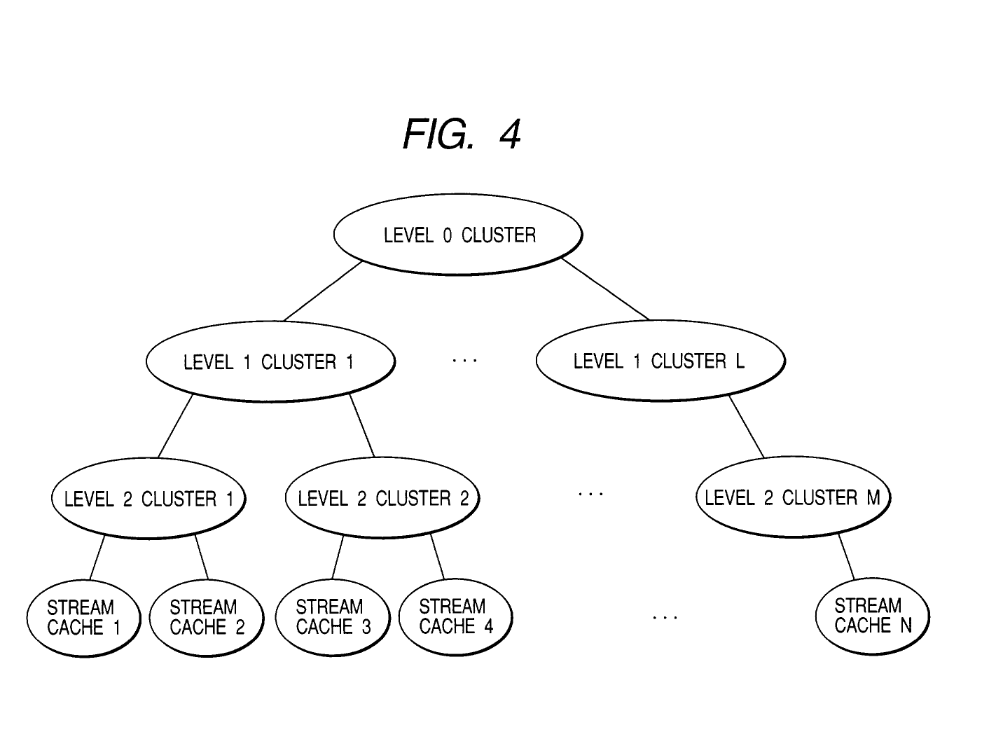

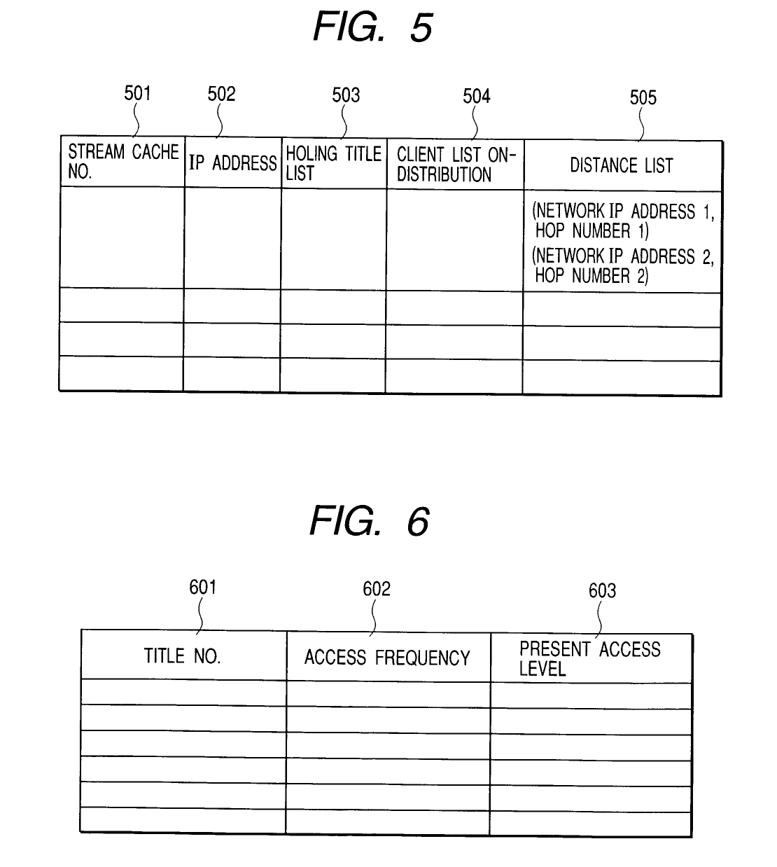

FIGS. 4 and 5 show the data structure of the cache information.

FIG. 4 shows the data structure of a module for managing the stream cache cluster, within the data structure of the cache information 301-3. This data structure forms the tree structure, wherein a stream cache cluster number is stored in the module of a branch, while a stream cache number in the module of a leaf thereof. The stream cache cluster of the each branch is made up with the stream caches stored in the leaves, corresponding to descendants thereof. In the example shown in FIG. 4, “level 1 cluster 1” is made up with “stream cache 1” to “stream cache 4”. This data structure is set by a stream server manager, before start-up of the operation of the system, and will not be altered or changed dynamically during the operation of the system.

FIG. 5 shows the data structure of a module for managing those other than the stream cache clusters, within the data structure of the cache information 301-3. With this data structure, an IP address 502, a holding title list 503, an on-distributing client list 504, and a distance list 505 thereof are stored, for each stream cache number 501.

The holding title list 503 indicates a list of titles, on which the said stream cache servers caching.

The on-distributing client list 504 indicates a list of the client numbers, onto which the said stream cache is now conducting the distribution operation.

The distance list 505 stores therein hop numbers from the said stream cache to the all network IP addresses (i.e., the number indicative of how many stages of rooters lie on the way of the communication). Thus, there is stored an arrangement of a set (i.e., the network IP addresses and the hop numbers).

FIG. 6 shows the data structure of the title information 301-4. With this data structure, the access frequency 602 and the present access level 603 are stored, for each title number 601.

The access frequency 602 stored therein the number of times when the replay request for the said title comes up to the stream server. The value of this field is used for the cache monitoring module 301-1 of the stream cache server 301 to make a check on the frequency of periodical accesses, and/or a determination on a necessity of the title copying/deleting accompanying with the increase/decrease in the access frequency.

The present access frequency level 603 stores therein the present access frequency level of said title (being an index for making determination, onto how may number of the stream caches should be cached the said title should). In the same manner, every time when checking the access frequency mentioned above, the access frequency is renewed to the newest access frequency level.

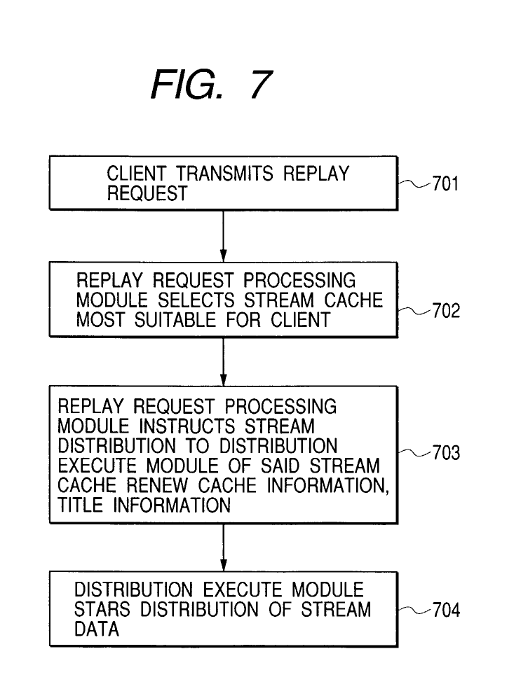

FIG. 7 shows a flowchart in the case when the replay request reaches from the client 303 to the stream server 301.

In a step 701, the client 303 transmits the replay request to the replay request processing module 301-2 of the stream server 301.

In a step 702, the replay request processing module 301-2 selects the most suitable stream cache for the client issuing the request mentioned above, by referring to the cache information 301-3. The “most suitable” stream cache mentioned herein means the stream cache that has the minimum hop number to the client, among those operating under the condition equal or less than a certain load level. Determination on whether the load is equal or less than a certain level or not can be made upon if the client number registered in the on-distributing client list 504 of the cache information 301-3 is equal or less than a certain level or not. Further, the distance between the each stream cache and the client can be determined by referring to the distance list 505 mentioned above.

In a step 703, the distribution request processing module 301-2 transmits the distribution command to the distribution execute module 302-1 of the stream cache, which is selected in the step 702. Further, it conducts addition of an entry of the on-distributing client list 504 of the title information 301-3, as well as an increment of the access frequency 602 of the title information 301-4.

In a step 704, the distribution execute module 302-1 executes the distribution of stream data.

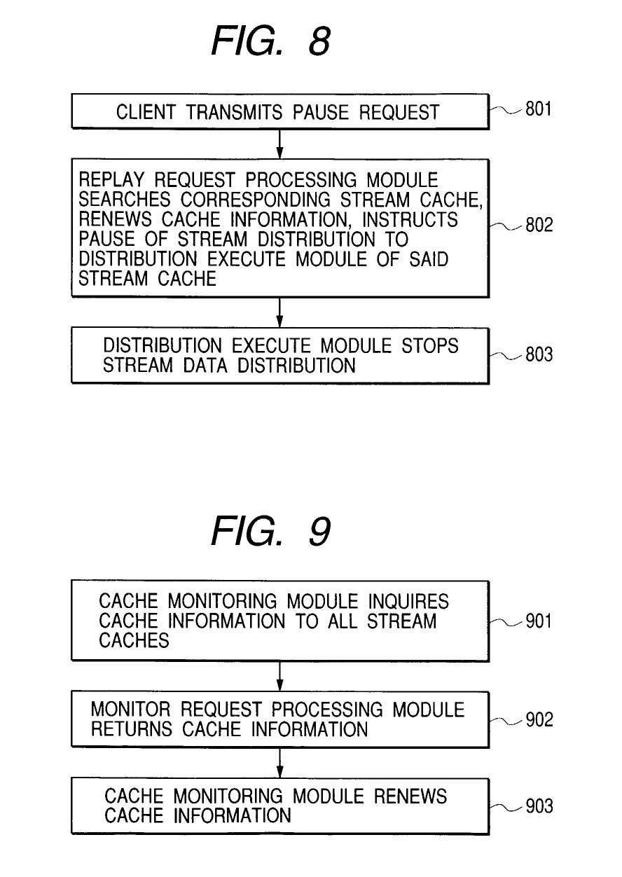

FIG. 8 shows a flowchart in the case when the pause request reaches from the client 303 to the stream server 301.

In a step 801, the client 303 transmits the pause request to the replay request processing module 301-2 of the stream server 301.

In a step 802, the replay request processing module 301-2 determines the stream cache to distribute the data stream to the client mentioned above. Determination of the stream cache mentioned above is carried out through searching of the on-distributing client list 504 of the cache information 301-3. Next, said client is deleted from the on-distributing client list 504. Lastly, the pause instruction is sent to the distribution execute module 302-1 of the stream cache mentioned above.

In a step 803, the distribution execute module 302-1 stops the distribution of stream data.

FIG. 9 shows a flowchart in the case when the stream server conducts the periodical monitoring on the stream cache. Thus, the operation shown in this flowchart is carried out, periodically (through triggering by means of a timer).

In a step 901, the cache monitoring module 301-1 of the stream sever 301 gives inquiry about the cache information to the monitor request processing module 302-2 of the each stream cache. Herein, the cache information to be inquired is only that corresponding to the distance list 505 in the data structure shown in FIG. 5 mentioned above.

Hereinafter, in a step 902, the monitor request processing module 302-2 gives the information mentioned above to the stream server 301, in response thereto, and in a step 903, the cache monitoring module 301-1 makes renewal of the cache information 301-3.

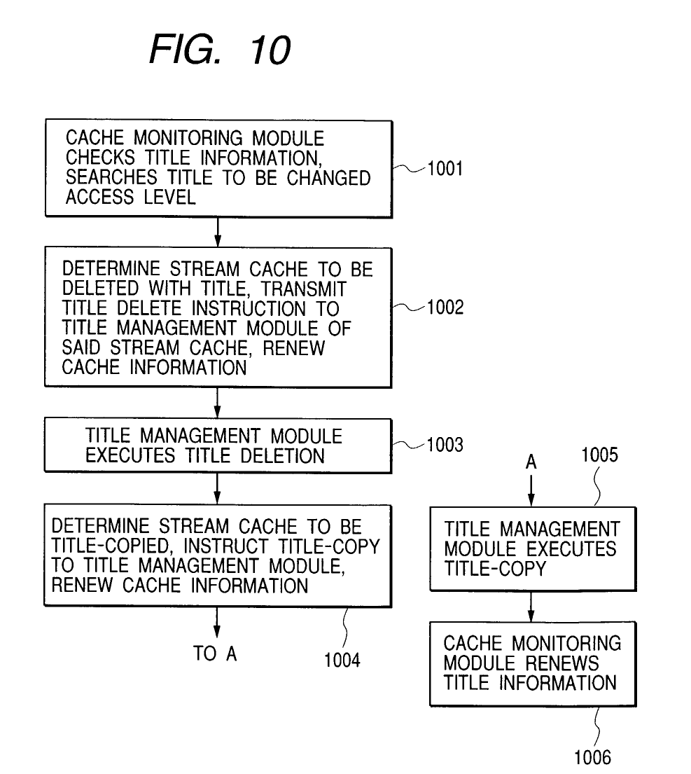

FIG. 10 shows a flowchart in the case when testing is made on the necessity of the title-copying/deleting accompanying with an increase/decrease in the access frequency. The operation shown in this flowchart is conducted periodically (through triggering by means of the timer).

The operation of this flowchart makes a change on the number of stream caches, which are caching the said titles, depending on the level of access frequency of the each title. The title of the access frequency level N (indicating that, the larger the number, the higher in the access frequency) is cached by means of one (1) stream cache for the stream cache cluster of the level N shown in FIG. 4 mentioned above. In the example shown in FIG. 4, the titles of 0, 1, and 2, in the level of access frequency, are cached by only one (1) stream cache for each of the stream cache clusters of 0, 1 and 2 in the level thereof, respectively. Further, the title having the access frequency level greater than two (2) are cached, by all of the stream caches.

In a step 1001, the cache monitoring module 301-1 of the stream server 301 makes searching on the title information 301-4. And, it compares the access frequency 602 to the present access frequency 603, thereby making determination on whether the number of stream caches for caching the said titles should be changed or not.

In a step 1002, determination is made on whether the access frequency level should be lowered or not, i.e., determining the number of the titles so as to diminish the number of stream caches to be held t as the caches. Upon determining on the titles mentioned above, a list of the stream caches can be obtained, which holds said titles therein. Obtaining of this list can be achieved through the search of the hold title list 503 of the cache information 301-3. Furthermore, with comparing to the data structure shown in FIG. 4 mentioned above, a list of the stream caches to be deleted with said title(s) can be obtained, so that the title of access frequency level N should be cached into only one (1) stream cache for the each stream cache cluster of the level N. And, the title deleting instruction is transmitted to the title management module 302-3 of the stream cache mentioned above. Further, the cache monitoring module 301-1 renews the cache information 301-3, in more detail, renewal of the hold title list 503 thereof.

In a step 1003, receiving the instruction mentioned above, the title management module 302-3 executes the title deleting following that instruction.

In a step 1004, in order to increase the access frequency, i.e., determination is made on the titles to be held as the caches, to rise up the number of the stream caches. Further, with comparing to the data structure shown in FIG. 4 mentioned above, a list of sets, including the stream caches, that should copy the said title from other caches, and the other stream caches, which should be an original of the copy, so that the title of the access frequency level N should be cached into the only one (1) stream cache for the each stream cache cluster of the level N. Upon obtaining the list mentioned above, the title-copy instruction is transmitted to the title management module 302-3 of the stream cache mentioned above. Further, the cache monitoring module 301-1 renews the cache information 301-3, in more detail, making the renewal of the hold title list 503 thereof.

In a step 1005, receiving the instruction mentioned above, the title management module 302-3 executes the title-copy of the title(s) designated from the stream cache designated, following that instruction.

In a step 1006, the cache monitoring module makes renewal of the title information 301-4. In more detail, after renewing the present access frequency level 603 to a newest access frequency level, all of the access frequencies 602 are initialized down to “0”, again.

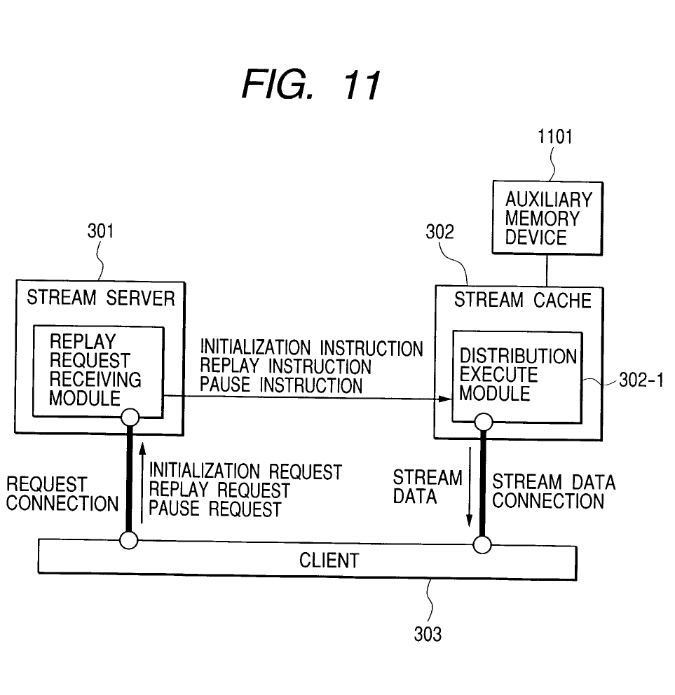

Among those constituent elements shown in the first embodiment according to the present invention, the client (303), the replay request processing module (301-2) of the stream server (301), and the distribution execute module (302-1) of the stream cache (302) can be also operated by using other embodiment. Such the embodiment will be explained in the form of a second embodiment of the present invention, by referring to FIG. 11.

FIG. 11 shows the structures of the client (303), the replay request processing module (301-2), and the distribution execute module (302-1), in that embodiment.

Between the client (303) and the replay request processing module (302-1) is established a request connection. Also, between the distribution execute module (302-1) and the client (303) is established a stream data connection. Furthermore, to the stream cache (302) is connected an auxiliary memory device.

On the request connection flow an initialization request, the replay request, and the pause request, which are transmitted from the client (303) to the replay request processing module (301-2). On the stream connection flows the stream data transmitted from the distribution execute module (302-1) to client (303).

Upon receipt of the initialization request, the replay request and the pause request from the client, the replay request processing module (301-2) transfers an initialization instruction, a replay instruction, and a pause instruction to the distribution execute module (302-1), respectively.

Upon receipt of the initialization instruction, the distribution execute module (302-1) establishes the stream data connection between the client. Information for making determination on a destination of the stream data connection is delivered together with the initialization instruction. Furthermore, upon receipt of the replay instruction, it also reads out the stream data from the auxiliary memory device (1101), thereby starting the distribution of the stream data read out onto the stream data connection. Information indicative of which stream data should be read out is contained in the replay instruction. Also, upon receipt of the stop instruction, the distribution execute module (302-1) stops the operation of reading-out and the distribution mentioned above. Until receiving this pause instruction, the distribution execute module (302-1) continues to execute read-out of the stream data from the auxiliary memory device (1101), little by little, and also the process of distributing the stream data to the client (303), in the order of read-out thereof through the stream data connection.

According to the present invention, the following effects can be obtained:

1) For the stream cache for distributing the stream data to the client, a node is selected from the stream caches scattered or distributed on the Internet, which operates under the load equal or less than a certain level and further is located near to the client in the sense of network distance. For this reason, it is possible to reduce the bandwidth necessary for the Internet. And, it is also possible to achieve decentralization of the load among the entire of the stream caches scatted or distributed on the Internet.

2) The title to be cached onto each stream cache is disposed equally on the Internet, depending on the access frequency thereof. Therefore, the storage for use in the stream data caching can be saved in the capacity thereof.

What is claimed is:

1. A data distribution method for use in a system, in which a first information device, a second information device, and a plural number of third information devices are connected to one another through a network, wherein said first information device transmits a data distribution request to said second device, and said second information device receiving said request distributes data to said first information device with using said third information device, comprising the following steps of:
a step for said second information device, to select at least one from said third information devices, which should transmits the data to said first information device, upon basis of a kind of the data held by each of said plural number of third information devices, a location information of said first information device on the network, and a load information of each of said third information devices;
a step for transmitting a data distribution command from said second information device to said third information device selected; and
a step for said third information device receiving said data distribution command, to execute data distribution to said first information device following to said data distribution command.

2. The data distribution method as described in the claim 1, further comprising the steps of:
a step for said second information device to make an inquiry about distance on the network between said third information device and each sub-network to said plural number of third information devices; and
a step for determining the third information device to be most short in the network distance from said first information device, upon basis of information obtained in the step mentioned above.

3. The data distribution method as described in the claim 1, further comprising the steps of:
a step for said second information device to record a number of data distributions from each of said third information devices, for each thereof; and
a step for selecting at least one from said third information devices, a number of said data distributions is equal or less than a predetermined value, when selecting said third information device for performing data transfer to said first information device.

4. The data distribution method as described in the claim 1, further comprising the steps of:
a step for said second information device to record an accumulated number of receiving the replay requests for each kind of the each data;
a step for transmitting an instructing to some of the third information devices, for copying the kinds of said data from the other third information devices, when a increase rate of said accumulated number comes up;
a step for said third information device receiving said instruction to execute the data copy following said instruction;
a step for transmitting an instruction to delete the kinds of said data to some of said third information devices, when a increase rate of said accumulated number comes down; and
a step for said third information device receiving said instruction to execute the data deletion following to said instruction.

5. An information device having an auxiliary memory device connected to a first information device and a second information device through a network, comprising:
means for establishing connection between said second information device designated with an initialize instruction when receiving said initialize instruction from said first information device; and
means for reading out data designated with a distribute instruction when receiving said distribute instruction from said first information device, and for starting an operation of transmitting the data read out through said connection to said second information device.

6. The information device as described in the claim 5, further comprising:
means for executing the reading out and the transmission of the data designated with said distribute instruction, by dividing said data into small units thereof and repeating the reading out and the transmission for each data divided.

7. A data distributing system, comprising:
a network;
a first information device connected to said network;
a second information device connected to said first information device through said network, for receiving a data distribute request from said first information device and for distributing data to said first information device following said request; and
third information devices, each having an auxiliary memory device, wherein
said second information device comprises:
means for receiving said data distribute request from said first information device;
means for transmitting a data distribute instruction to said third information device, when receiving said data distribute request; and
means for including a kind of data to be transmitted and information in relation to the first information device as a destination of transmission into said data distribute instruction, and wherein
said third information device comprises:
means for reading out the data designated with said data distribute instruction from the auxiliary memory device and for distributing to the first information device designated with said data distribute instruction.

8. A data distribution method for a second information device connected to a first information device and a plural number of third information devices through a network, comprising the following steps of:
receiving a data distribute request from said first information device;
selection at least one from said third information devices, to transmits the data to said first information device, upon basis of a kind of the data held by each of said plural number of third information devices, a location information of said first information device on the network, and a load information of each of said third information devices; and
transmitting a data transmit instruction to said selected third information device.

9. An information device connected to a first information device and a plural number of information devices through a network, comprising:
means for receiving a data distribute request from said information device;
means for selection at least one from said third information devices, to transmits the data to said first information device, upon basis of a kind of the data held by each of said plural number of third information devices, a location information of said first information device on the network, and a load information of each of said third information devices; and
means for transmitting a data transmit instruction to said selected third information device.
